(19) United States
(12) Patent Application Publication
(10) Pub. No.: US 2026/0268586 A1
(43) Pub. Date: Sep. 10, 2026

(54) CONTENT SERVER, CLIENT TERMINAL, IMAGE DISPLAY SYSTEM, RENDERING DATA TRANSMISSION METHOD, AND DISPLAY IMAGE GENERATION METHOD

(71) Applicant: Sony Interactive Entertainment Inc., Tokyo (JP)

(72) Inventor: Hirofumi Kaneko, Tokyo (JP)

(73) Assignee: Sony Interactive Entertainment Inc., Tokyo (JP)

(21) Appl. No.: 19/663,099

(22) Filed: Apr. 29, 2026

Related U.S. Application Data
(63) Continuation of application No. PCT/JP2023/039246, filed on Oct. 31, 2023.

(51) Int. Cl. G06T 15/20; G06T 15/04

(52) U.S. Cl. CPC G06T 15/20; G06T 15/04

(57) ABSTRACT

A content server renders images of objects which are visible from a virtual camera, and generates learning textures for the respective objects. The content server generates learning textures while setting the virtual camera in different positions and directions, performs machine learning according to the learning textures to generate, for each object, a texture model configured to acquire a color value from UV coordinates and a direction, and transmits the texture models to a client terminal. By using the texture model, the client terminal generates a display image representing an object with a color corresponding to a viewpoint at a time immediately before display.

### CROSS-REFERENCE TO RELATED APPLICATION

This application is a Continuation application under 35 U.S.C. § 111 of International Patent Application No. PCT/JP2023/039246, filed Oct. 31, 2023, the entire disclosure of which are incorporated herein by reference for all purposes.

### TECHNICAL FIELD

The present disclosure relates to a content server, a client terminal, an image display system, a rendering data transmission method, and a display image generation method for displaying an image of a three-dimensional display world.

### BACKGROUND

With recent expansion of communication networks and development of an image processing technology, a variety of electronic content has been enjoyed in any viewing environment. In the field of electronic games, for example, a system has become popular in which a server collects operation information inputted to individual client terminals and distributes game images to which the collected information is applied as necessary, thereby allowing a plurality of players to participate in the same game from everywhere.

### SUMMARY

Electronic content, not limited to electronic games, that involves generating a moving image on a real time basis according to a user operation and distributing the moving image from a server can use an abundant processing environment in the server. This facilitates display of high-quality images while minimizing influence on processing performance of client terminals. On the other hand, a process of transmitting operation information from a client terminal and a process of distributing a moving image from a server having received the information are ever present, so that it is difficult to instantly apply, to the display, a change in viewpoint or line of sight that occurs during the process.

The present disclosure has been made in view of the abovementioned problem, and an object thereof is to provide a technique of, in content image processing that involves distribution from a server, displaying a high-quality image with high responsiveness to a change in viewpoint or line of sight.

In order to solve the above problem, an aspect of the present disclosure relates to a content server. The content server includes an input information acquisition section that acquires, from a client terminal that generates a display image representing a three-dimensional display world, information of a display viewpoint specifying the display image, a learning texture generation section that generates a plurality of textures for learning representing color value distributions on a surface of an object, by rendering images of the object viewed from a plurality of viewpoints for learning generated according to the display viewpoint, a texture model generation section that generates, by machine learning using the textures for learning as labeled data, a texture model configured to output a color value according to a viewpoint change, and a rendering data transmission section that transmits the texture model and geometry data of the display world, associated with one another, to the client terminal.

Another aspect of the present disclosure relates to a client terminal. The client terminal includes an input information acquisition section that acquires information of a display viewpoint specifying a display image representing a three-dimensional display world, a rendering data acquisition section that acquires a texture model together with geometry data of the display world from a server, the texture model being configured to output a color value according to a viewpoint change and being generated by machine learning using textures for learning representing color value distributions on a surface of an object viewed from a plurality of viewpoints for learning, and an image generation section that generates a display image by acquiring a color value corresponding to the latest display viewpoint with use of the texture model and outputs the display image to a display device.

Still another aspect of the present disclosure relates to an image display system. The image display system includes a client terminal that generates and displays a display image representing a three-dimensional display world and a content server that transmits rendering data to be used for generating the display image. The content server includes an input information acquisition section that acquires, from the client terminal, information of a display viewpoint specifying the display image, a learning texture generation section that generates a plurality of textures for learning representing color value distributions on a surface of an object, by rendering images of the object viewed from a plurality of viewpoints for learning generated according to the display viewpoint, a texture model generation section that generates, by machine learning using the textures for learning as labeled data, a texture model configured to output a color value according to a viewpoint change, and a rendering data transmission section that transmits the texture model and geometry data of the display world, associated with one another, to the client terminal. The client terminal includes an input information acquisition section that acquires information of the display viewpoint, a rendering data acquisition section that acquires the texture model and the geometry data, and an image generation section that generates a display image by acquiring a color value corresponding to the latest display viewpoint with use of the texture model and outputs the display image to a display device.

Yet another aspect of the present disclosure relates to a rendering data transmission method. The rendering data transmission method includes a step of acquiring, from a client terminal that generates a display image representing a three-dimensional display world, information of a display viewpoint specifying the display image, a step of generating a plurality of textures for learning representing color value distributions on a surface of an object, by rendering images of the object viewed from a plurality of viewpoints for learning generated according to the display viewpoint, a step of generating, by machine learning using the textures for learning as labeled data, a texture model configured to output a color value according to a viewpoint change, and a step of transmitting the texture model and geometry data of the display world, associated with one another, to the client terminal.

Yet another aspect of the present disclosure relates to a display image generation method. The display image generation method includes a step of acquiring information of a display viewpoint specifying a display image representing a three-dimensional display world, a step of acquiring a texture model together with geometry data of the display world from a server, the texture model being configured to output a color value according to a viewpoint change and being generated by machine learning using textures for learning representing color value distributions on a surface of an object viewed from a plurality of viewpoints for learning, and a step of generating a display image by acquiring a color value corresponding to the latest display viewpoint with use of the texture model and outputting the display image to a display device.

It is to be noted that any combination of the above constituent elements and conversions of expressions of the present disclosure between a method, a device, a system, a computer program, a data structure, a recording medium, and the like are also effective as aspects of the present disclosure.

According to the present disclosure, in content image processing that involves distribution from a server, a high-quality image can be displayed with high responsiveness to a change in viewpoint or line of sight.

### BRIEF DESCRIPTION OF DRAWINGS

FIG. 1 is a diagram depicting a configuration example of an image display system to which the present embodiment is applicable.

FIG. 2 is a diagram for explaining a delay in display when a display viewpoint has changed in a mode where a content server generates a display image.

FIG. 3 is a diagram for explaining images defined by ray tracing.

FIG. 4 is a diagram for explaining data to be transmitted from a content server to a client terminal in the present embodiment.

FIG. 5 is a diagram for explaining textures in a visible range which are generated by the content server in the present embodiment.

FIG. 6 is a diagram depicting an internal circuit configuration of the client terminal in the present embodiment.

FIG. 7 is a diagram depicting functional block configurations of the client terminal and the content server in the present embodiment.

FIG. 8 is a diagram schematically depicting a manner in which a learning texture generation section of the content server generates learning textures in the present embodiment.

FIG. 9 is a diagram for explaining a procedure for generating a display image by an image generation section of the client terminal using a texture model in the present embodiment.

FIG. 10 is a flowchart of a process procedure for generating rendering data by the content server and transmitting the rendering data to the client terminal in the present embodiment.

FIG. 11 is a flowchart of a process procedure for generating a display image by the client terminal using rendering data, and outputting the display image in the present embodiment.

### DETAILED DESCRIPTION

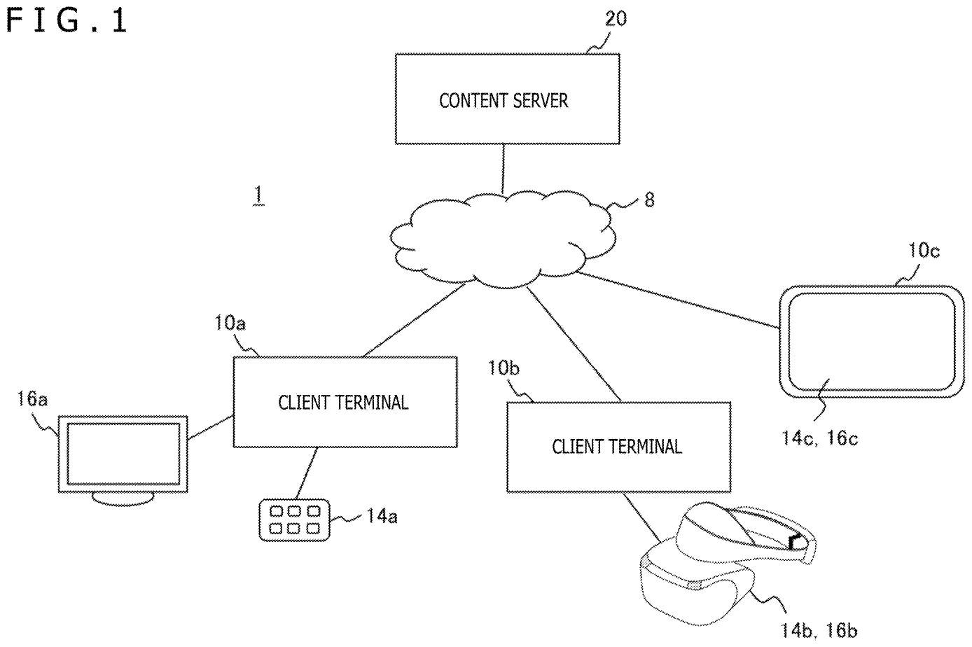

FIG. 1 depicts a configuration example of an image display system to which the present embodiment is applicable. An image display system 1 includes client terminals 10a, 10b, and 10c for displaying images according to user operations and a content server 20 that provides data for display. Input devices 14a, 14b, and 14c for receiving user operations and display devices 16a, 16b, and 16c for displaying images are connected respectively to the client terminals 10a, 10b, and 10c. Between the client terminals 10a, 10b, and 10c and the content server 20, communication can be established via a network 8 such as WAN (World Area Network) or LAN (Local Area Network).

Connection between the client terminals 10a, 10b, and 10c and the display devices 16a, 16b, and 16c and connection between the client terminals 10a, 10b, and 10c and the input devices 14a, 14b, and 14c may be individually established in a wired or wireless manner. Alternatively, two or more of these devices may be integrally formed. For example, in FIG. 1, the client terminal 10b is connected to a head mount display as the display device 16b. The field of view of an image displayed on the head mount display can be changed according to a motion of a user wearing the head mount display on the head. Thus, the head mount display also functions as the input device 14b.

In addition, the client terminal 10c is a mobile terminal and has the display device 16c and the input device 14c formed integrally, the input device 14c serving as a touch pad covering a screen of the display device 16c. As described above, appearances of the depicted devices and the connection form therebetween are not limited. The number of the client terminals 10a, 10b, and 10c or the number of the content servers 20 to be connected to the network 8 are also not limited. Hereinafter, the client terminals 10a, 10b, and 10c are collectively referred to as the client terminals 10, the input devices 14a, 14b, and 14c are collectively referred to as the input devices 14, and the display devices 16a, 16b, and 16c are collectively referred to as the display devices 16.

The input device 14 may be a common input device such as a controller, a keyboard, a mouse, a touch pad, or a joy stick, or may be any of various sensors including a motion sensor and a camera included in the head mount display, for example, or a combination thereof. The input device 14 supplies a substance of a user operation to the client terminal 10. The display device 16 may be a common display such as a liquid crystal display, a plasma display, an organic EL (Electroluminescent) display, a wearable display, or a projector. An image outputted from the client terminal 10 is displayed on the display device 16.

The content server 20 provides data of content that involves image display, to the client terminal 10. The type of the content is not particularly limited, and the content may be any of an electronic game, a viewing image, a web page, a video chat using avatars, and the like. In the present embodiment, the content server 20 successively acquires, from the client terminal 10, information concerning a user operation inputted to the input device 14, applies the information to a display target world, and causes an image representing the resultant world to be displayed on the client terminal 10 side.

In the present embodiment, a display image is rendered by using 3DCG (Three-Dimensional Computer Graphics). In the field of 3DCG, a physical phenomenon that occurs in a display target space is expressed more precisely to achieve realistic image representation. As physics-based rendering for achieving this, ray tracing has been known. In ray tracing, propagation of various types of light reaching a viewpoint, such as light traveling from a light source and light reflected diffusely or specularly from a surface of an object, is precisely calculated, so that a color change or brightness change caused by movement of the viewpoint or the object itself can be expressed in a more realistic manner.

When high-definition images are generated by ray tracing at a high rate using an abundant processing environment of the content server 20, high-quality content can be enjoyed without depending on the processing performance of the client terminal 10. On the other hand, exchange of various types of data between the content server 20 and the client terminal 10 is necessary, so that a delay in the display is likely to occur when a user operation is made on the client terminal 10 side or when a viewpoint or line of sight with respect to a display world has been changed. Hereinafter, the position of a viewpoint or the direction of a line of sight with respect to the display world may be referred to simply as a “viewpoint,” and a viewpoint corresponding to a display field of view may be referred to as a “display viewpoint.”

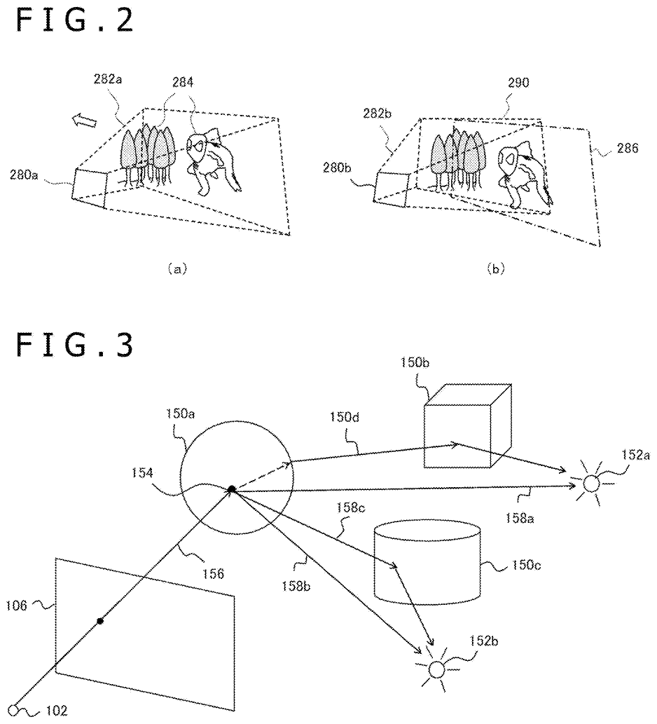

FIG. 2 is a diagram for explaining a delay in display when a display viewpoint has changed in a mode where the content server 20 generates a display image. In a case where an image generated by the content server 20 is displayed on the client terminal 10 side, a certain period of time is required to display the generated image on the client terminal 10 side after the client terminal 10 transmits information of a display viewpoint to the content server 20 and then the content server 20 generates the image according to the information, as described above. This results in occurrence of a delay in the field of view of a displayed image when an actual display viewpoint has changed.

In FIG. 2, (a) depicts a manner in which the content server 20 generates an image. The content server 20 sets a view screen 280a so as to correspond to a display viewpoint recognized at this time and renders, on the view screen 280a, images 284 included in a view frustum 282a corresponding to the view screen 280a. Here, it is assumed that the viewpoint at the time of display is shifted to the left side as indicated by an arrow. In this case, at the time when the transmitted image is displayed on the client terminal 10 side, a view screen 280b has been shifted to the left side as depicted in (b).

That is, a proper field of view 290 corresponding to a view frustum 282b at the time of display is deviated from a field of view 286 of the image transmitted from the content server 20. If this deviation is ignored and the image transmitted from the content server 20 is displayed as it is, a delay in the field of view of the displayed image occurs in relation to the display viewpoint change. This can cause discomfort that cannot be overlooked. In particular, in a case where the display device 16 is a head mount display, a sense of immersion in virtual reality is impaired, or motion sickness is induced, so that the quality of a user experience is deteriorated.

As one of the solutions to this problem, reprojection is performed in which the client terminal 10 corrects the field of view according to the viewpoint at the time of display. For example, it is conceivable that the content server 20 may transmit in advance an image of a wide range formed by considering future movement of a display viewpoint and that the range of field of view at the time of display may be cut off and displayed on the client terminal 10 side. In this case, at least a delay in the display field of view is corrected. However, since information supplied to the client terminal 10 is limited to two-dimensional information, it is difficult to express a color change depending on the direction in which an object is viewed, with the same precision as ray tracing.

FIG. 3 is a diagram for explaining images defined by ray tracing. In ray tracing, rays are generated to pass through individual pixels on a view screen 106 from a display viewpoint 102, and colors are sampled at points where the rays reach, so that pixel values are determined. Accordingly, a shadow, a reflective image formed by specular reflection, and an image appearing through a translucent object, as well as the color of an object obtained by diffusion reflection can be expressed precisely. In the example of FIG. 3, a ray 156 having reached a point 154 on a surface of a sphere object 150a probabilistically reaches a light source 152a or 152b (ray 158a or 158b) or reaches another object 150c (ray 158c) after being reflected specularly.

In a case where the object 150a is translucent, a ray 150d having passed through the object from the point 154 and then been refracted reaches another object 150b. The rays having reached the other objects 150b and 150c reach the power sources 152a and 152b subsequently. The color at the point 154 is expressed by superimposing of the colors of these rays. That is, the colors of the other objects 150b and 150c as well as the color of the object 150a itself are applied to the color at the point 154.

As a result, a reflective image of the other object 150c and an image of the object 150b which is seen through the object 150a are expressed on the surface of the object 150a. In a case where an object is a floor or the like which is not depicted, an image of a shadow is formed according to the positional relation between the light source and the other object 150a, for example. Here, if the position of the display viewpoint 102, the direction of the line of sight, and hence the incident direction of the ray 156 reaching the spherical object 150a have changed, a subsequent path of the ray also changes. This results in a change of the color at the point 154. Hereinafter, such a color change at the same point that corresponds to a viewpoint change is referred to as a “viewpoint dependent effect.”

When this ray tracing is executed on the client terminal 10 side, the display world can be expressed with correct colors according to a viewpoint at the time of display. However, this increases processing loads, and thus, it is difficult to realize such a display world as described above with the processing capability of the client terminal 10 in some cases. In view of this, in the present embodiment, color information that enables responding to a display viewpoint change is prepared in the content server 20. Accordingly, a display image having a field of view and colors both corresponding to a viewpoint at the time of display can be generated with a low processing load on the client terminal 10.

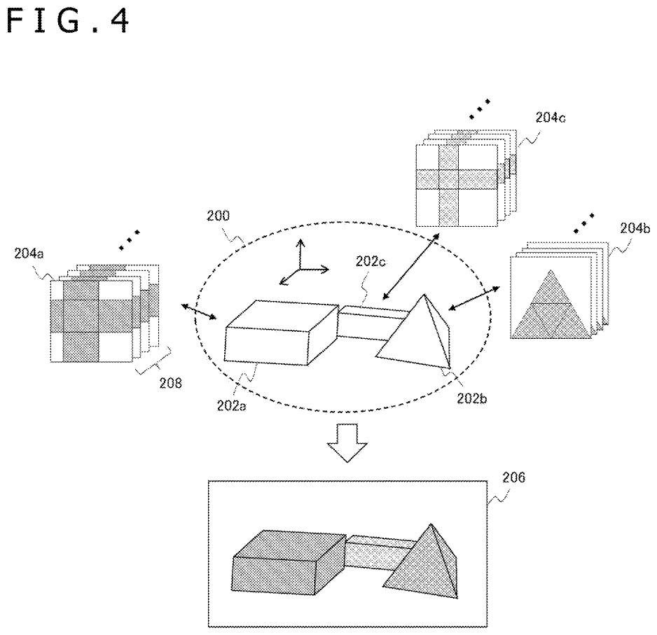

FIG. 4 is a diagram for explaining data to be transmitted from the content server 20 to the client terminal 10 in the present embodiment. The content server 20 controls a three-dimensional space 200 of a display world according to content settings of an electronic game or the like. In the example of FIG. 4, there are a plurality of objects 200a, 200b, and 200c in the three-dimensional space 200. The content server 20 generates geometry data indicating the positions and shapes of the objects 200a, 200b, and 200c in the three-dimensional space 200 and textures 204a, 204b, and 204c indicating color distributions on surfaces of the respective objects 200a, 200b, and 200c.

Each of the textures 204a, 204b, and 204c is data in which a color value c at each point is mapped in a plan region obtained by two-dimensional UV unwrapping of the surfaces of the object, as depicted in FIG. 4. The color value c includes elements of three primary colors: R (red); G (green); and B (blue), for example. The client terminal 10 acquires the geometry data and the textures 204a, 204b, and 204c and generates a display image 206 by ray tracing or rasterization.

In a case where ray tracing is adopted, the client terminal 10 sets a view screen corresponding to a viewpoint at a time immediately before display, generates a ray for each pixel on the view screen, and then acquires the destination of each ray on an object by using the geometry data. Next, by sampling color values at the destinations from the textures 204a, 204b, and 204c, the client terminal 10 obtains pixel values of the display image 206. In a case where rasterization is adopted, by projecting polygons of objects onto a view screen corresponding to a viewpoint at a time immediately before display with use of the geometry data and pasting portions of the textures 204a, 204b, and 204c corresponding to the polygons, the client terminal 10 obtains pixel values of the display image 206.

With the textures 204a, 204b, and 204c of high definition prepared in the content server 20, even when a data transfer time occurs, the client terminal 10 can generate the display image 206 having a field of view corresponding to a viewpoint at the time of display, with high quality. Further, in order to express a viewpoint dependent effect as described above, the content server 20 of the present embodiment prepares variations of texture data in consideration of a viewpoint change during the transfer time. In FIG. 4, data having these variations is represented by superimposing of a plurality of textures (e.g., texture data 208).

The plurality of textures are generated on the basis of different viewpoints with respect to the object. Therefore, the client terminal 10 changes a texture to be referred, according to a display viewpoint change, so that a viewpoint dependent effect can be expressed. In a case where the object 200a, 200b, or 200c moves or deforms according to a user operation or the like, the content server 20 updates the geometry data and the texture data and transmits the updated data to the client terminal 10 at a predetermined time step. As a result, a color change can be expressed according to both a viewpoint change and a change in an object itself.

In the present embodiment, the texture data 208 is actually a neural network configured to present a result of machine learning using a plurality of textures based on different viewpoints as labeled data. The client terminal 10 inputs information of a viewpoint at a time immediately before display to the neural network to acquire an appropriate color value at that time, and sets the acquired color value as a pixel value of the display image 206. Accordingly, even if a limited number of textures are actually generated by the content server 20, a change in color of the object can be naturally expressed when a display viewpoint has changed.

As a technique for expressing a three-dimensional space by using a neural network, NeRF (Neural Radiance Fields) has been known (for example, see Ben Mildenhall, et. al., “NeRF: Representing Scenes as Neural Radiance Fields for View Synthesis,” Communications of the ACM, January 2022, vol. 65, no. 1, p. 99-106). With this technique, a plurality of images expressing the same scene are used as labeled data, and regression using MLP (Multilayer Perceptron) is performed to obtain data indicating three-dimensional information concerning the scene. This data is a function f including a neural network in which a five-dimensional parameter having position coordinates (x, y, z) and a direction vector (θ, φ) in a three-dimensional space is used as input while a volume density σ and a color value c (RGB) are used as output, as expressed below.

$$( c , σ ) = f ( x , y , z , {θ}_{,} φ ) \qquad [ Math . 1 ]$$

Even when the content server 20 generates NeRF data of this type at a predetermined time step and the client terminal 10 receives this data and performs volume rendering, an image corresponding to a viewpoint at the time of display can be generated. In this case, however, the learning cost in the content server 20 and the rendering cost in the client terminal 10 are increased, and thus, the processing efficiency may be degraded in return. Therefore, the content server 20 of the present embodiment performs machine learning to derive a function F configured to output only a color value c in the abovementioned manner. Specifically, the function F which is used as texture data in the present embodiment is as follows.

$$c = F ( u , v , θ , φ ) \qquad [ Math . 2 ]$$

Here, (u, v) represents position coordinates in the UV coordinate system of the texture. That is, the function F is a neural network in which a four-dimensional parameter having the position coordinates (u, v) and the direction vector (θ, φ) is used as input while a color value c (RGB) is used as output. According to the function F, a color value c at the position coordinates (u, v) on a texture corresponding to a certain point on a surface of an object can be properly changed with use of the direction vector (θ, φ) of the line of sight. In addition, compared to NeRF, the order of the parameter is low. Thus, the learning cost and the rendering cost can be reduced.

A technique for obtaining a texture of an object by machine learning using NeRF is disclosed, for example, in Zhiqin Chen, et. al., “MobileNeRF: Exploiting the Polygon Rasterization Pipeline for Efficient Neural Field Rendering on Mobile Architectures,” 2023 IEEE/CVF Conference on Computer Vision and Pattern Recognition (CVPR), 2023, p. 16569-16578. This technique is applicable to the present embodiment. Hereinafter, a neural network that expresses the function F is referred to as a “texture model.”

With a display viewpoint at the time of reception of information from the client terminal 10 as a reference, the content server 20 predicts a subsequent viewpoint change during a short period of time until display, and generates a plurality of textures for use in machine learning. That is, if all possible viewpoint changes during the short period of time can be recognized, color information concerning an object viewed from viewpoints other than the above viewpoints is unnecessary. Therefore, in the present embodiment, textures of a surface of an object for use in learning are limited to those in a visible range, so that the speed of a process of generating texture data in the content server 20 is increased.

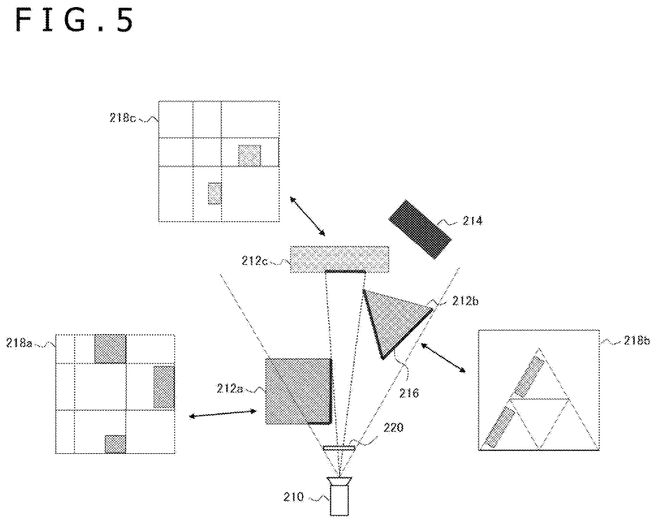

FIG. 5 is a diagram for explaining textures in a visible range which are generated by the content server 20 in the present embodiment. The content server 20 basically generates a viewpoint for generating a texture for use in learning, in a surrounding region of a display viewpoint acquired at that time. Hereinafter, viewpoints generated here which include the display viewpoint are referred to as “learning viewpoints,” and textures generated on the basis of the learning viewpoints are referred to as “learning textures.” FIG. 5 depicts a bird's eye view of a three-dimensional space that includes a virtual camera 210 corresponding to a certain learning viewpoint and objects 212a, 212b, 212c, and 214.

A range of a surface of each of the objects 212a, 212b, 212c, and 214 visible from the virtual camera 210 is restricted depending on its position and direction. In FIG. 5, such ranges are indicated by thick lines (e.g., thick line 216). The content server 20 generates learning textures 218a, 218b, and 218c for the objects 212a, 212b, and 212c, respectively, the learning textures having information concerning colors in the visible range only. For example, the content server 20 sets a view screen 220 corresponding to the virtual camera 210 and performs ray tracing. At this time, regarding rays reaching the respective objects 212a, 212b, and 212c, information concerning colors at points where the rays reach is acquired on the basis of the theory depicted in FIG. 3, and the acquired information is written into a texture buffer.

As a result, the learning textures 218a, 218b, and 218c only some portions of which have color values stored are generated as depicted in FIG. 5. The content server 20 generates similar textures while changing the position and direction of the virtual camera 210, and then performs machine learning to generate a texture model for each object. It is to be noted that, in FIG. 5, the object 214 is hidden by the other objects 212b and 212c and is invisible from the virtual camera 210. In this case, the content server 20 does not need to generate a texture of the object 214. Even if the other objects 212b and 212c are transparent and the object 214 is visible therethrough, an image of the object 214 appearing therethrough is incorporated in the textures 218b and 218c for the other objects 212b and 212c.

An area of a surface of an object which area is expressed by one pixel on the view screen 220 depends on the distance from the virtual camera 210 to the object. The area is smaller as the object is closer to the virtual camera 210. That is, the resolution of a texture generated by the content server 20 in the abovementioned manner varies according to the distance to an object. As a result, the density of an amount of information concerning a texture model obtained by learning textures becomes higher when the object is closer to the virtual camera 210. This tendency is the same as the tendency of a detail level required for each object when a display image is generated. As a result, a process of generating a texture model to a process of displaying an image can be performed with high efficiency at high speed without excessive learning or rendering cost.

It is to be noted that the content server 20 may limit objects for which viewpoint dependent effects are to be expressed, by selecting those from among the objects present in the visible range. For example, when an object is in a position close to a display viewpoint, the color of a surface of the object is likely to change largely in response to a slight viewpoint change, but when an object is in a far position, the color of a surface of the object is less likely to change much in response to a viewpoint change. Therefore, the content server 20 may not perform machine learning of textures for an object in a far position because such an object gives a less strange feeling to a user even when a viewpoint dependent effect is not expressed, and may transmit one texture generated according to the display viewpoint to the client terminal 10. By performing only the process necessary and sufficient to generate texture models as described above, precise images can be displayed with a small delay even when a step of preparing images from a plurality of viewpoints has been performed.

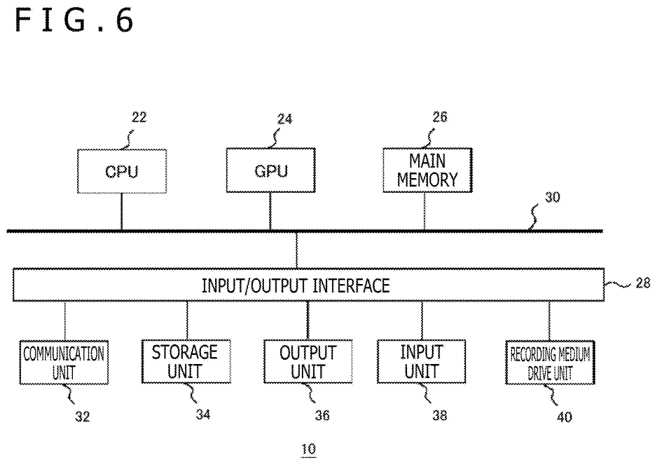

FIG. 6 depicts an internal circuit configuration of the client terminal 10. The client terminal 10 includes a CPU (Central Processing Unit) 22, a GPU (Graphics Processing Unit) 24, and a main memory 26. These units are mutually connected via a bus 30. To the bus 30, an input/output interface 28 is further connected. Connected to the input/output interface 28 are a communication unit 32 including a peripheral device interface such as a USB (Universal Serial Bus) or IEEE (Institute of Electrical and Electronics Engineers) 1394 or a network interface of a wired or wireless LAN, a storage unit 34 such as a hard disk drive or a nonvolatile memory, an output unit 36 that outputs data to the display device 16, an input unit 38 to which data is inputted from the input device 14, and a recording medium drive unit 40 that drives a removable recording medium such as a magnetic disk, an optical disk, or a semiconductor memory.

The CPU 22 generally controls the client terminal 10 by executing an operating system stored in the storage unit 34. The CPU 22 further executes various programs having been read from a removable recording medium and loaded into the main memory 26 or having been downloaded via the communication unit 32. The GPU 24 has the function of a geometry engine and the function of a rendering processor. The GPU 24 performs rendering according to a rendering command from the CPU 22 and stores display images in a frame buffer not depicted. Then, the GPU 24 converts the display images stored in the frame buffer into video signals and outputs the video signals to the output unit 36. The main memory 26 includes a RAM (Random Access Memory). Programs and data required for processes are stored in the main memory 26. The content server 20 may have a similar internal circuit configuration.

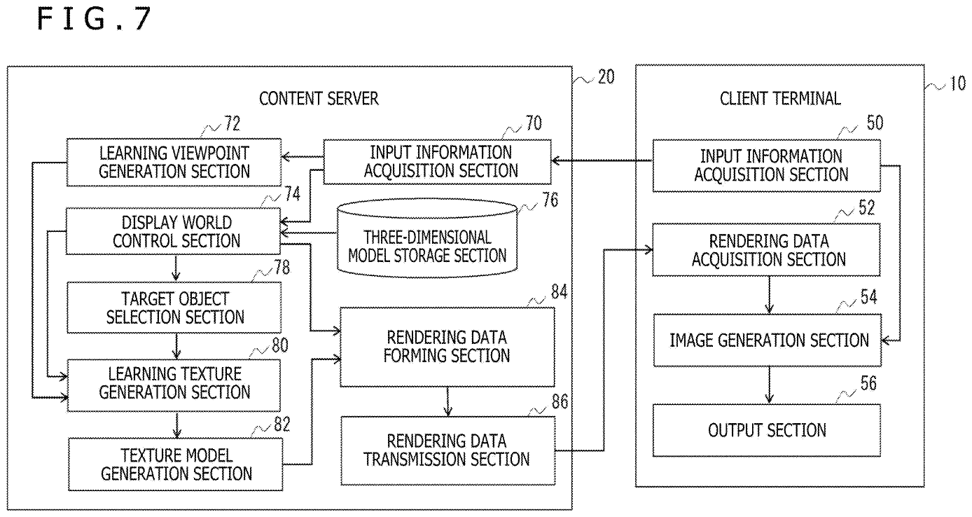

FIG. 7 depicts functional block configurations of the client terminal 10 and the content server 20 in the present embodiment. It is to be noted that FIG. 7 depicts functional blocks related to image processing although the client terminal 10 and the content server 20 may perform various types of processing necessary for execution of content, including sound processing.

The depicted functional blocks can be implemented by hardware including the CPU, the GPU, and the various memories depicted in FIG. 6, and can be implemented by software with a program having been loaded from a recording medium or the like onto a memory to exert various functions such as a data input function, a data retaining function, an image processing function, and a communication function. Therefore, a person skilled in the art will understand that these functional blocks can be implemented in many different ways, for example, by means of hardware only, by means of software only, or by a combination thereof. These functional blocks are not limited to any one of them.

The client terminal 10 includes an input information acquisition section 50 that acquires input information such as a user operation, a rendering data acquisition section 52 that acquires data for image rendering from the content server 20, an image generation section 54 that generates a display image, and an output section 56 that outputs data concerning the display image. The input information acquisition section 50 acquires a substance of a user operation from the input device 14, as appropriate. Examples of the user operation include a selection of content, startup of content, and a command input to content under execution.

Further, the input information acquisition section 50 acquires information of a display viewpoint for a display world from the input device 14 or a head mount display, as appropriate or at a predetermined time interval. A technique for detecting the position and posture of the head of a user wearing the head mount display, and acquiring information of a viewpoint on the basis of the position and posture is well known. Such a technique may be adopted in the present embodiment. The input information acquisition section 50 supplies the acquired information to the content server 20 and the image generation section 54, if necessary.

The rendering data acquisition section 52 acquires rendering data to be used for generating a display image from the content server 20, and decodes and expands the rendering data if necessary. The rendering data herein includes geometry data indicating the position or three-dimensional shape of an object present in the display world, a texture model associated with an object for which a viewpoint dependent effect is to be expressed, and data regarding a texture associated with an object for which no viewpoint dependent effect is to be expressed. The rendering data acquisition section 52 acquires a set of the rendering data at a display frame rate or a predetermined rate which is set separately from the display frame rate.

The image generation section 54 generates a display image at a display frame rate by using the rendering data. That is, the image generation section 54 uses geometry data included in the last acquired rendering data to arrange an object in a display target three-dimensional space, acquires information of the latest display viewpoint from the input information acquisition section 50, and sets a corresponding view screen. Then, the image generation section 54 renders an image of the object on the view screen by ray tracing or rasterization. At this time, the image generation section 54 uses a texture model to determine the color of an object for which a viewpoint dependent effect is to be expressed. Specifically, the image generation section 54 uses the texture model to acquire color values at points on a surface of the object which color values correspond to rendering target pixels, according to the corresponding UV coordinates and line-of-sight direction.

On the other hand, the image generation section 54 uses a texture to determine the color of an object for which no viewpoint dependent effect is to be expressed. Specifically, the image generation section 54 samples, from the texture, color values at points on a surface of the object which color values correspond to rendering target pixels, according to the corresponding UV coordinates. It is to be noted that the image generation section 54 may generate, for an object for which a viewpoint dependent effect is to be expressed, the entire texture corresponding to the latest display viewpoint by using the texture model and then use the texture for image rendering. In this case, the image generation section 54 may sample, from the texture generated by the image generation section 54 itself, color values at points on a surface of the object which color values correspond to rendering target pixels. The output section 56 outputs data regarding the display image generated by the image generation section 54 to the display device 16 at a display frame rate such that the data is displayed.

The content server 20 includes an input information acquisition section 70 that acquires input information from the client terminal 10, a learning viewpoint generation section 72 that generates learning viewpoints, a display world control section 74 that controls a display world, a three-dimensional model storage section 76 that stores a three-dimensional model of an object, a target object selection section 78 that selects an object for which a viewpoint dependent effect is to be expressed, a learning texture generation section 80 that generates learning textures, a texture model generation section 82 that generates a texture model, a rendering data forming section 84 that forms a set of image rendering data, and a rendering data transmission section 86 that transmits the image rendering data to the client terminal 10.

The input information acquisition section 70 acquires a substance of a user operation and information of a viewpoint from the client terminal 10 as appropriate or at a predetermined time interval. The learning viewpoint generation section 72 generates a plurality of learning viewpoints for generating learning textures. The learning viewpoint generation section 72 generates learning viewpoints at the latest display viewpoint acquired by the input information acquisition section 70 and in a surrounding region of the acquired display viewpoint according to a predetermined rule. As described above, a texture model is sufficient as long as it is information covering the entire movable range in which a viewpoint can move during the maximum amount of time until display using the relevant data is performed in the client terminal 10.

Therefore, the learning viewpoint generation section 72 arranges a predetermined number of learning viewpoints uniformly inside, for example, a sphere having a predetermined radius centered at the latest display viewpoint. Here, the predetermined radius is set to, for example, a value obtained by multiplying an estimated highest speed of movement of the viewpoint by the maximum amount of time until display using the data is performed. Instead of arranging the learning viewpoints uniformly, the learning viewpoint generation section 72 may arrange more learning viewpoints in a range in which the viewpoint is predicted to move, according to the condition of the display world or the like. Further, the learning viewpoint generation section 72 may uniformly set, for the viewpoint at each position, a predetermined number of directions of lines of sight or may set more lines of sight in a direction in which the line of sight is predicted to move.

The display world control section 74 controls a three-dimensional display world presented as content, according to, for example, the substance of the user operation acquired by the input information acquisition section 70. For example, in a case where the content is an electronic game, the display world control section 74 arranges an object necessary for the game, such as a user character, in a virtual space as a stage of the electronic game and gives a motion to the object according to a command inputted by a user or a program specification. Three-dimensional models of objects present in the display world are stored in the three-dimensional model storage section 76, and the display world control section 74 reads out a three-dimensional model, as appropriate, for use in constructing the display world.

Further, in the constructed display world, the display world control section 74 sets the display viewpoint acquired by the input information acquisition section 70. The display world control section 74 supplies, for example, model data concerning an object included in the latest display world to the learning texture generation section 80 and the rendering data forming section 84, if necessary.

The target object selection section 78 selects an object for which a viewpoint dependent effect is to be expressed, on the basis of the latest condition of the display world that is controlled by the display world control section 74. For example, the target object selection section 78 sets, as a target object, an object present within a predetermined range from the display viewpoint in the display world. However, the selection criterion is not limited to this as long as an object for which expression of a viewpoint dependent effect is highly required can be selected. The selection may be made according to the original size, apparent size, material, original color, or the like of an object. Only one criterion may be used for the selection, or a plurality of criteria may be combined.

The learning texture generation section 80 generates learning textures of the object selected as an object for which a viewpoint dependent effect is to be expressed, according to the plurality of learning viewpoints generated by the learning viewpoint generation section 72. The learning texture generation section 80 preferably generates, for each object, a plurality of learning textures having information concerning colors only in a visible region, as described above, by using a technique that enables high-quality image rendering, such as path tracing. By performing machine learning using the learning textures as labeled data, the texture model generation section 82 generates a texture model for each object as described above.

The rendering data forming section 84 forms a set of rendering data to be transmitted to the client terminal 10. Therefore, for an object for which no viewpoint dependent effect is to be expressed, the rendering data forming section 84 generates a texture corresponding to the latest display viewpoint. Also in this case, by using a technique that enables high-quality image rendering, such as path tracing, the rendering data forming section 84 generates, for each object, a texture having information concerning colors only in a visible region. The rendering data forming section 84 further generates geometry data of the display world. Here, the rendering data forming section 84 may generate geometry data that indicates only information concerning a portion of an object present in the display world which portion is visible from the display viewpoint.

As a technique for transmitting such geometry data, one disclosed in Joerg H. Muller, et. al., “Shading Atlas Streaming,” ACM Transactions on Graphics, November 2018, vol. 37, no. 6, article no. 199 can be adopted, for example. With this technique, the size of data to be transmitted from the content server 20 to the client terminal 10 can be further reduced. The rendering data forming section 84 associates the geometry data with the texture model generated by the texture model generation section 82, for an object for which a viewpoint dependent effect is to be expressed, and associates the geometry data with the texture generated by the rendering data forming section 84 itself, for the other objects. Then, the rendering data forming section 84 uses the resultant data as rendering data.

It is to be noted that the rendering data forming section 84 may provide a difference in a detail level of geometry data and hence the roughness of a polygon between an object for which a viewpoint dependent effect is to be expressed and the other objects. As long as a viewpoint dependent effect is expressed with high definition, a user can recognize the shape by a color change. Thus, even if the roughness of a polygon is increased, that is, the number of polygons per unit area is reduced, an effect on the appearance is little. Therefore, the rendering data forming section 84 may make an adjustment such that the roughness of a polygon of an object for which a viewpoint dependent effect is to be expressed is made higher than those of the other objects. An existing technique can be applied for adjustment of the roughness of the polygon.

Accordingly, the size of geometry data to be transmitted from the content server 20 to the client terminal 10 can be further reduced. The rendering data transmission section 86 compresses and encodes the set of rendering data formed by the rendering data forming section 84, if necessary, and transmits the data to the client terminal 10 at a predetermined rate.

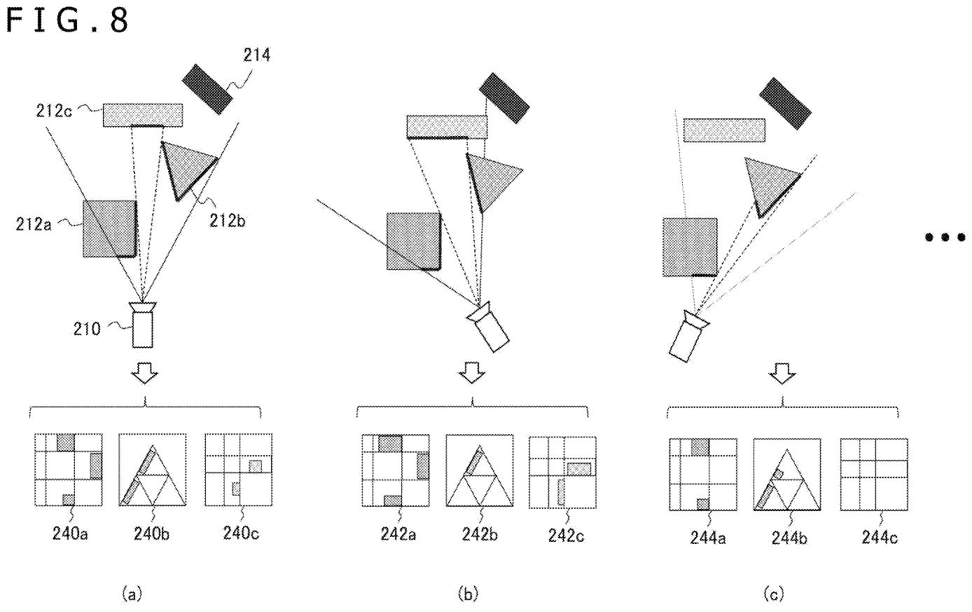

FIG. 8 schematically depicts a manner in which the learning texture generation section 80 of the content server 20 generates learning textures. Similarly to FIG. 5, the upper side in FIG. 8 depicts bird's eye views of three-dimensional spaces each including the virtual camera 210 corresponding to the viewpoint and the objects 212a, 212b, 212c, and 214. As depicted in (a), (b), (c), . . . , the learning texture generation section 80 sets the virtual camera 210 so as to correspond to a plurality of learning viewpoints and then generates images of the objects 212a, 212b, and 212c which are present in the visible range, with high quality.

Accordingly, a plurality of learning textures based on different viewpoints are generated for each object. In FIG. 8, learning textures 240a, 242a, 244a, . . . are generated for the object 212a, learning textures 240b, 242b, 244b, . . . are generated for the object 212b, and learning texture 240c, 242c, 244c, . . . are generated for the object 212c. With the viewpoint dependent effect, learning textures having different colors even at the same point on the surface of the same object depending on a viewpoint can be generated.

Further, each of the learning textures has information concerning colors viewed from the corresponding viewpoint in the visible range. Therefore, even if the learning textures are generated for the same object, they have different ranges of pixels including color information. Machine learning is performed using these textures as labeled data, so that smooth interpolations between the discrete states depicted in (a), (b), (c), . . . are made. Accordingly, a color value that varies according to a viewpoint change can be obtained, and when an invisible portion of the object becomes visible, such a change can be naturally expressed. It is to be noted that, in the example of FIG. 8, the object 214 is invisible from the virtual camera 210 as described above, and therefore, the content server 20 does not generate learning textures for the object 214.

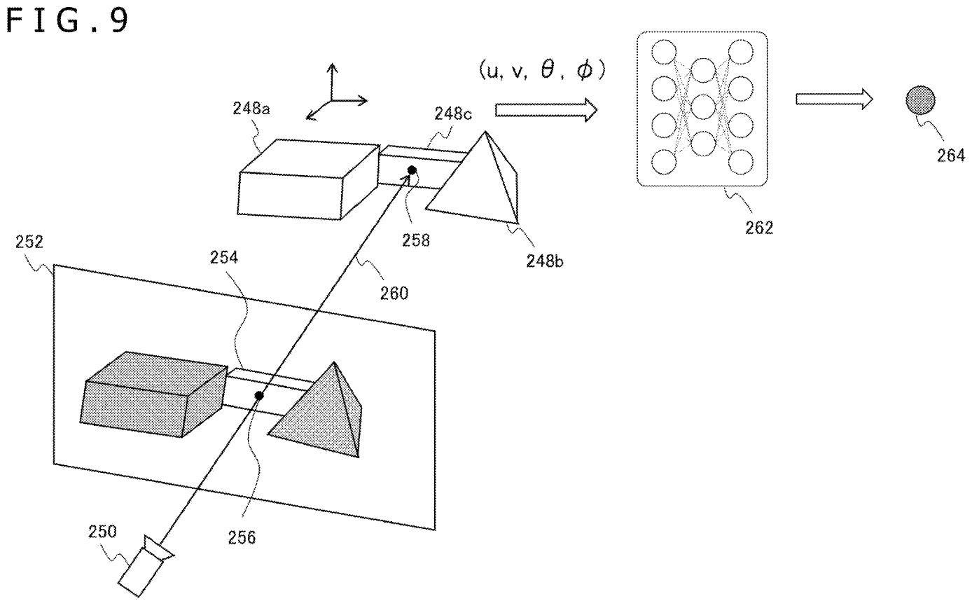

FIG. 9 is a diagram for explaining a procedure for generating a display image by the image generation section 54 of the client terminal 10 using a texture model. First, the image generation section 54 arranges objects 248a, 248b, and 248c in a display target three-dimensional space on the basis of geometry data transmitted from the content server 20. As described above, the geometry data of the objects 248a, 248b, and 248c may have information in the visible range only. Further, the image generation section 54 acquires information of the latest display viewpoint from the input information acquisition section 50 and sets a virtual camera 250 and a view screen 252 corresponding to this display viewpoint.

The image generation section 54 renders images of the objects 248a, 248b, and 248c on the view screen 252 by ray tracing or rasterization. To determine a color of a pixel 256 on an image 254, for example, the image generation section 54 identifies the object 248c corresponding to the image 254 and then acquires the UV coordinates (u, v) of a point 258 on a surface of the object 248c which point corresponds to the pixel 256. In addition, the image generation section 54 acquires the direction (θ, φ) of a line of sight 260 with respect to the surface of the object 248c.

Then, the image generation section 54 inputs the acquired parameter (u, v, θ, φ) to a texture model 262 associated with the object 248c, thereby obtaining a color value 264 at the pixel 256. The image generation section 54 sequentially determines pixel values for an object for which a viewpoint dependent effect is to be expressed, by a similar process, thereby rendering an image of the object. For an object for which no viewpoint dependent effect is to be expressed, the image generation section 54 samples a texture associated with the object, on the basis of the UV coordinates corresponding to a pixel, thereby sequentially determining pixel values and rendering an image.

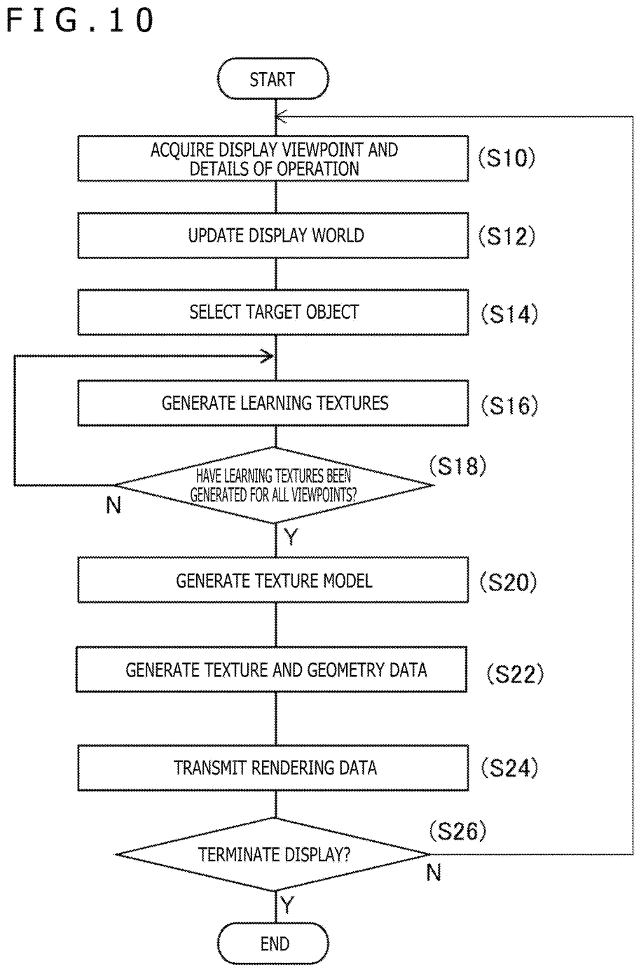

Next, operation of the content server 20 and operation of the client terminal 10 which can be performed by the abovementioned configuration will be explained. FIG. 10 is a flowchart of a process procedure for generating rendering data by the content server 20 and transmitting the rendering data to the client terminal 10. This flowchart is started in a state where, with the client terminal 10 having established communication, a user has selected display target content and an initial image is being displayed. It is to be noted that FIG. 10 depicts steps performed in order, but some of the steps may be performed in parallel with others.

In this state, the input information acquisition section 70 of the content server 20 acquires viewpoint information and a substance of a user operation from the client terminal 10 (S10). The display world control section 74 updates the state of an object in the display world according to the substance of the user operation or the like, if necessary (S12). The target object selection section 78 selects an object for which a viewpoint dependent effect is to be expressed, according to a distance from the latest display viewpoint or the like (S14). For example, the target object selection section 78 selects, as a target object, an object present within a predetermined range from the display viewpoint.

Then, by ray tracing or the like, the learning texture generation section 80 renders an image representing the state of the target object viewed from one of a plurality of learning viewpoints generated by the learning viewpoint generation section 72 on the basis of the display viewpoint. Accordingly, the learning texture generation section 80 generates learning textures for each target object (S16). The learning texture generation section 80 repeats processing of S16 until the learning texture is generated for every learning viewpoint (N in S18). After the learning texture is generated for every learning viewpoint (Y in S18), the texture model generation section 82 performs machine learning by using the generated learning textures as labeled data, to generate a texture model for each target object (S20).

Meanwhile, for an object for which no viewpoint dependent effect is to be expressed, the rendering data forming section 84 generates a texture by rendering an image of the object viewed from the display viewpoint by ray tracing or the like and generates geometry data in the visible range (S22). Then, the rendering data forming section 84 associates a texture model of an object for which a viewpoint dependent effect is to be expressed, a texture of an object for which no viewpoint dependent effect is to be expressed, and geometry data with each other, and uses the resultant data as a set of rendering data.

The rendering data transmission section 86 compresses and encodes the rendering data, if necessary, and transmits the rendering data to the client terminal 10 (S24). When there is no need to terminate the image display, for example, when the content is ended, the content server 20 repeats processing of S10 to S24 (N in S26). As the need to terminate the image display arises, the content server 20 ends the entire processing (Y in S26).

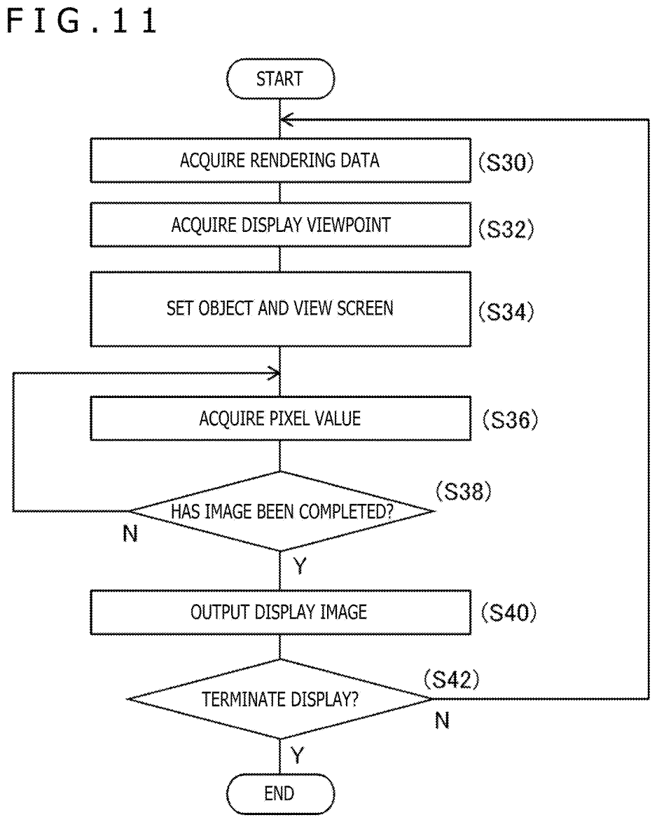

FIG. 11 is a flowchart of a process procedure for generating a display image by the client terminal 10 using rendering data, and outputting the display image. This flowchart is performed in a state where a user has selected display target content and the client terminal 10 is transmitting viewpoint information and a substance of a user operation to the content server 20 while causing an initial image to be displayed on the display device 16. It is to be noted that FIG. 11 depicts steps performed in order, but some of the steps may be performed in parallel with others.

In this state, the rendering data acquisition section 52 of the client terminal 10 acquires the rendering data from the content server 20, and decodes and expands the rendering data, if necessary (S30). The image generation section 54 acquires information of a display viewpoint at that time via the input information acquisition section 50 (S32). Further, the image generation section 54 sets an object in the three-dimensional space on the basis of the geometry data included in the rendering data and sets a view screen corresponding to the display viewpoint (S34). Next, for each pixel on the view screen, the image generation section 54 acquires a pixel value expressing an image of the object (S36).

More specifically, for an object for which a viewpoint dependent effect is to be expressed, the image generation section 54 acquires pixel values by using a texture model according to the procedure indicated in FIG. 9. For an object for which no viewpoint dependent effect is to be expressed, the image generation section 54 acquires pixel values by sampling an associated texture. For every pixel on the view screen, the image generation section 54 repeats processing of S36 until the pixel values of all pixels on the view screen are acquired to complete the image (N in S38).

After the image has been completed (Y in S38), the output section 56 outputs the relevant image as a display image of one frame to the display device 16 (S40). When there is no need to terminate the image display, for example, when the content is ended, the client terminal 10 repeats processing of S30 to S40 (N in S42). As the need to terminate the image display arises, the client terminal 10 ends the entire processing (Y in S42).

According to the present embodiment having been described so far, in electronic content image processing, the content server 20 prepares, for each object, a texture model for deriving a viewpoint dependent effect, i.e., a color change depending on a viewpoint, and transmits the texture model as well as the geometry data to the client terminal 10. Accordingly, an image representing a display world with a field of view and colors corresponding to a viewpoint at a time immediately before display can be generated, and high-quality image representation can be achieved with a small delay.

The content server 20 uses abundant resources to render images viewed from a plurality of learning viewpoints, with high precision, and then performs machine learning, thereby generating a texture model. Compared to the common NeRF in which the density of an object in three dimensions is taken into consideration, the order of an input/output parameter in this texture model can reduced. Therefore, the learning and rendering processing loads can be lessened. In addition, since the content server 20 uses images rendered from the same learning viewpoints to perform learning, an amount of information concerning the resultant texture model for an object is larger as the distance from the display viewpoint to the object is shorter. This tendency is the same as the tendency of a detail level of an object required in display. Thus, a texture model can be always generated by a necessary and sufficient processing amount.

Moreover, for an object for which a viewpoint dependent effect does not need to be expressed, a texture model is not generated, and a texture rendered from a display viewpoint is associated with the object, so that the processing load for generating a texture model or acquiring color values by using the texture model can be minimized. In addition, since the color or outline of an object can be expressed with high precision by the texture model, an effect on the appearance can be reduced even when the roughness of a polygon is increased. This results in reduction of a data transfer amount. Consequently, a high-quality image can be displayed with high responsiveness to a change in viewpoint or line of sight.

The present disclosure has been explained on the basis of the embodiment. The embodiment exemplifies the present disclosure, but a person skilled in the art will understand that various modifications can be made to a combination of the constituent elements or the process steps of the embodiment and that these modifications are also within the scope of the present disclosure.

For example, in the present embodiment, the content server 20 generates a new learning texture having a necessary viewpoint, according to the latest display viewpoint transmitted from the client terminal 10. Alternatively, the content server 20 may use, as at least some of the learning textures, a texture generated in the past or a texture generated for another client terminal 10. When the movement of an object in the display world is smaller or a display viewpoint change is smaller, a variation of textures of the object becomes smaller. Thus, even if a texture model generated by using the past textures is used, a display image in which an effect on the appearance is little can be generated.

Accordingly, a processing load for generating a texture model on the content server 20 can be reduced, and display can be performed with a small delay. It is to be noted that whether or not to use textures generated in the past, the proportion of the past textures to be used, and the allowable range of the generation time of the past textures to be used, for example, may be adaptively determined according to the movement of an object or the magnitude of a display viewpoint change. If an object remains unmoved, the content server 20 may temporarily generate learning textures on the basis of learning viewpoints that cover the entire movable range of the display viewpoint. With the texture model generated, the subsequent process of generating a learning texture or performing machine learning can be omitted.

As described so far, the present disclosure can be used for any of various information processing devices such as a content server, a game device, a head mount display, a display device, a mobile terminal, and a personal computer, and for an image display system including any one of them, for example.

What is claimed is:

1. A content server comprising:
at least one processor; and
a memory device storing instructions that, when executed by the at least one processor, cause the content server to:
acquire, from a client terminal information of a display viewpoint specifying a display image representing a three-dimensional display world;
generate a plurality of textures for learning representing color value distributions on a surface of an object, by rendering images of the object viewed from a plurality of viewpoints for learning generated according to the display viewpoint;
generate, by machine learning using the textures for learning, a texture model configured to output a color value according to a viewpoint change; and
transmit the texture model and geometry data of the display world, associated with one another, to the client terminal.

2. The content server according to claim 1, wherein the instructions, when executed by the at least one processor, further cause the content server to generate a neural network as the texture model for each object, the neural network being configured to output a color value according to UV coordinates on the surface of the object and a direction of a line of sight.

3. The content server according to claim 1, wherein the instructions, when executed by the at least one processor, further cause the content server to generate, for each of the viewpoints for learning, the texture for learning representing a color value distribution in a region of the surface of the object that is visible from the viewpoint for learning.

4. The content server according to claim 1, wherein the instructions, when executed by the at least one processor, further cause the content server to generate the textures for learning with respect to an object selected according to a predetermined criterion among objects present in the display world.

5. The content server according to claim 4, wherein the instructions, when executed by the at least one processor, further cause the content server to generate the textures for learning with respect to an object present within a predetermined range from the display viewpoint.

6. The content server according to claim 4, wherein the instructions, when executed by the at least one processor, further cause the content server to generate, by rendering an image of an object other than the selected object viewed from the display viewpoint, a texture representing a color value distribution on a surface of the object; and transmit the geometry data and the texture associated with one another to the client terminal.

7. The content server according to claim 6, wherein the instructions, when executed by the at least one processor, further cause the content server to set a density of a polygon of the selected object lower than a density of the other object.

8. The content server according to claim 1, wherein the instructions, when executed by the at least one processor, further cause the content server to:
acquire a substance of a user operation from the client terminal;
change the display world according to the substance of the user operation; and
transmit, at a predetermined rate, the texture model and the geometry data that are updated according to a change of the display world.

9. A client terminal comprising:
at least one processor; and
a memory device storing instructions that, when executed by the at least one processor, cause the client terminal to:
acquire information of a display viewpoint specifying a display image representing a three-dimensional display world;
acquire a texture model together with geometry data of the display world from a server, the texture model being configured to output a color value according to a viewpoint change and being generated by machine learning using textures for learning representing color value distributions on a surface of an object viewed from a plurality of viewpoints for learning; and
generate a display image by acquiring a color value corresponding to a latest display viewpoint with use of the texture model and outputs the display image to a display device.

10. An image display system comprising:
a client terminal configured to generate and display a display image representing a three-dimensional display world; and
a content server configured to:
transmit rendering data to be used for generating the display image;
acquire, from the client terminal, information of a display viewpoint specifying the display image;
generate a plurality of textures for learning representing color value distributions on a surface of an object, by rendering images of the object viewed from a plurality of viewpoints for learning generated according to the display viewpoint;
generate, by machine learning using the textures for learning, a texture model configured to output a color value according to a viewpoint change;
transmit the texture model and geometry data of the display world, associated with one another, to the client terminal;
wherein the client terminal is configured to:
acquire information of the display viewpoint;
acquire the texture model and the geometry data;
generate a display image by acquiring a color value corresponding to a latest display viewpoint with use of the texture model; and
output the display image to a display device.

11. A rendering data transmission method comprising:
acquiring, from a client terminal, information of a display viewpoint specifying a display image representing a three-dimensional display world;
generating a plurality of textures for learning representing color value distributions on a surface of an object, by rendering images of the object viewed from a plurality of viewpoints for learning generated according to the display viewpoint;
generating, by machine learning using the textures for learning as labeled data, a texture model configured to output a color value according to a viewpoint change; and
transmitting the texture model and geometry data of the display world, associated with one another, to the client terminal.

12. A display image generation method comprising:
acquiring information of a display viewpoint specifying a display image representing a three-dimensional display world;
acquiring a texture model together with geometry data of the display world from a server, the texture model being configured to output a color value according to a viewpoint change and being generated by machine learning using textures for learning representing color value distributions on a surface of an object viewed from a plurality of viewpoints for learning; and
generating a display image by acquiring a color value corresponding to a latest display viewpoint with use of the texture model and outputting the display image to a display device.

13. The display image generation method of claim 12, further comprising generating a neural network as the texture model for each object, the neural network being configured to output a color value according to UV coordinates on the surface of the object and a direction of a line of sight.

14. The display image generation method of claim 12, further comprising generating, for each of the viewpoints for learning, the texture for learning representing a color value distribution in a region of the surface of the object that is visible from the viewpoint for learning.

15. The display image generation method of claim 12, further comprising generating the textures for learning with respect to an object selected according to a predetermined criterion among objects present in the display world.

16. The display image generation method of claim 15, further comprising generating the textures for learning with respect to an object present within a predetermined range from the display viewpoint.

17. The display image generation method of claim 15, further comprising generating, by rendering an image of an object other than the selected object viewed from the display viewpoint, a texture representing a color value distribution on a surface of the object; and transmit the geometry data and the texture associated with one another to the client terminal.

18. The display image generation method of claim 17, further comprising setting a density of a polygon of the selected object lower than a density of the other object.

19. A non-transitory computer-readable medium storing computer-readable instructions that, when executed by a computer, cause the computer to perform operations comprising:
acquiring, from a client terminal, information of a display viewpoint specifying a display image representing a three-dimensional display world;
generating a plurality of textures for learning representing color value distributions on a surface of an object, by rendering images of the object viewed from a plurality of viewpoints for learning generated according to the display viewpoint;
generating, by machine learning using the textures for learning as labeled data, a texture model configured to output a color value according to a viewpoint change; and
transmitting the texture model and geometry data of the display world, associated with one another, to the client terminal.

20. A non-transitory computer-readable medium storing computer-readable instructions that, when executed by a computer, cause the computer to perform operations comprising:
acquiring information of a display viewpoint specifying a display image representing a three-dimensional display world;
acquiring a texture model together with geometry data of the display world from a server, the texture model being configured to output a color value according to a viewpoint change and being generated by machine learning using textures for learning representing color value distributions on a surface of an object viewed from a plurality of viewpoints for learning; and
generating a display image by acquiring a color value corresponding to a latest display viewpoint with use of the texture model and outputting the display image to a display device. 10
